(19) United States
(12) Patent Application Publication
(10) Pub. No.: US 2009/0079581 A1
(43) Pub. Date: Mar. 26, 2009

(54) Novelty container with cover-activated musical playback

(75) Inventors: Chin Yoon Wong, Mississauga (CA); Christopher Goh, Mississauga (CA)

Correspondence Address: JOHN S. HALE;GIPPLE & HALE, 6665-A OLD DOMINION DRIVE, MCLEAN, VA, 22101, US

(73) Assignee: Seagull Pewter Inc.

(21) Appl. No.: 11/902,426

(22) Filed: Sep. 21, 2007

(51) Int. Cl. G08B 3/00; B65D 43/16

(52) U.S. Cl. 340/692

(57) ABSTRACT

The invention is directed to a novelty container with a cover mounted to the container operable between closed and open positions which activate and deactivate a sound generating assembly. An electrically operated sound generating assembly is mounted to the container, having a sound generator circuit board, a battery electrically connected to the sound generator circuit board and a speaker electrically connected to the circuit board. A switch is mounted to the container to activate the sound generating assembly and has a resilient electrically conductive first member attached to the container and electrically connected to sound generating assembly, biased towards and engaging an electrically conductive second member attached to the container and electrically connected to the sound generating assembly. A flexible electrically insulating element attached to the cover and adjacent to the resilient electrically conductive first member which is reciprocatingly moveable in concert with the operation of the cover.

### RELATED APPLICATIONS

There is no related application.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention is generally directed toward a container for novelty items featuring a unique switch operable to automatically activate or de-activate an included musical playback assembly when the container is opened or closed.

2. Background of the Invention

Novelty containers featuring musical playback upon lifting, or otherwise opening their respective covers are previously known. Generic terms for these devices include “music box” or “jewelry box.” However, the aforementioned containers have historically been either expensive to manufacture and accordingly expensive to purchase, or of dubious quality and consequently unreliable in operation or of limited longevity generally due to the fact that the containers are mechanical in nature. The container is usually wound up and a repeated tune is played throughout the mechanical striking of a series of miniature tines or tuning fork like openings. More recently, so-called “talking” greeting cards have become available incorporating a disposable, battery operated electronic sound playback device. A message is spoken or a musical selection played when the card is opened in order to augment the printed text. These cards are relatively inexpensive to purchase, but the devices are designed for a limited number of playback events and are insufficiently durable for daily use or longer term service spanning months or years and have a battery which is not replaceable.

The instant invention is a novelty container that may be used as a gift or a container for a gift containing commercially available electronic sound playback devices combined with a novel switching mechanism for controlling activation of the aforementioned device. The switch is inexpensive to manufacture, yet durable and appropriate for long term, repeated use. Moreover, the sound generating assembly and switch are disposed on a unitary mounting surface permitting easy attachment or retrofitting to existing containers. In addition, the battery may be replaced when the battery runs down. Consequently, this invention is more economical to manufacture yet equal in durability and sound reproduction qualities to similarly functioning devices costing significantly more.

### SUMMARY OF THE INVENTION

In general, the present invention is a novel combination in a novelty gift container including a sound playback assembly in the form of an electronic assembly that plays a high quality sound such as a licensed piece of music and a reciprocating switch assembly. The switch assembly comprises electrically conductive contact elements separable by a strip shaped insulating member attached to the cover of the novelty container, so that lifting of the novelty container's cover causes corresponding reciprocating movement of the strip insulating member. Reciprocation of this strip insulating member opens or closes an electrical circuit thereby stopping or activating a musical playback assembly mounted to the container. Thus, the electronic sound device is mounted into a gift box so that when the box is opened, the song or music piece is played.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is a top plan view and elevation of the invention's sound playback assembly and switch.

FIG. 1A is a side elevation view of the assembly of FIG. 1;

FIG. 2 is a an enlarged elevation view of the circuit board of the sound playback assembly with the switch in an enlarged exploded view showing the circuit disconnected.

FIG. 3 is a side elevation view of the present invention showing the circuit board of the sound playback assembly with the switch in an enlarged exploded view showing the circuit activated.

FIG. 4 is top plan view of a container including multiple hinge sections permitting the container cover to open into a position coplanar with the base of the container; and

FIG. 5 is a side elevation view of the container in FIG. 4 with the side panel broken away.

### DESCRIPTION OF THE INVENTION

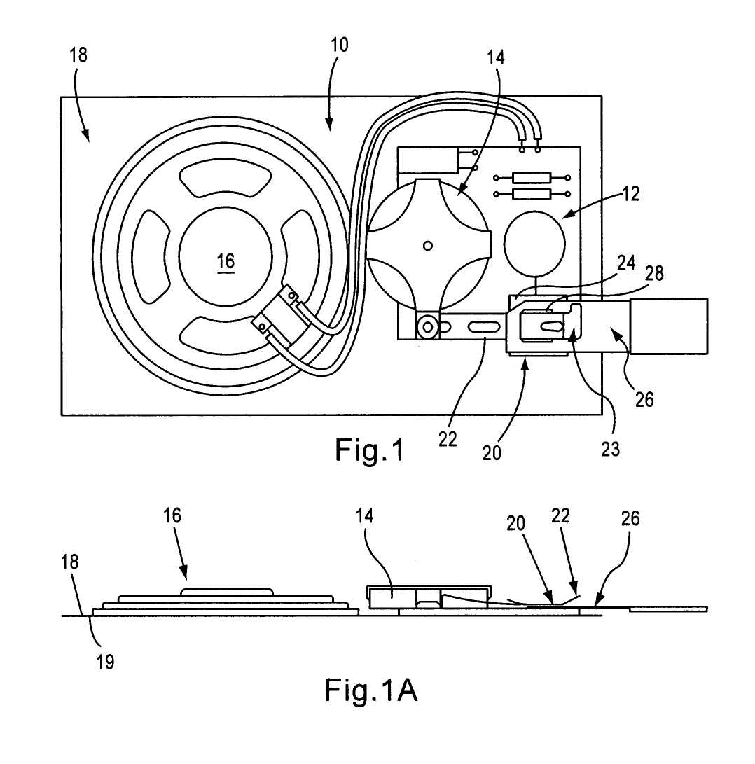

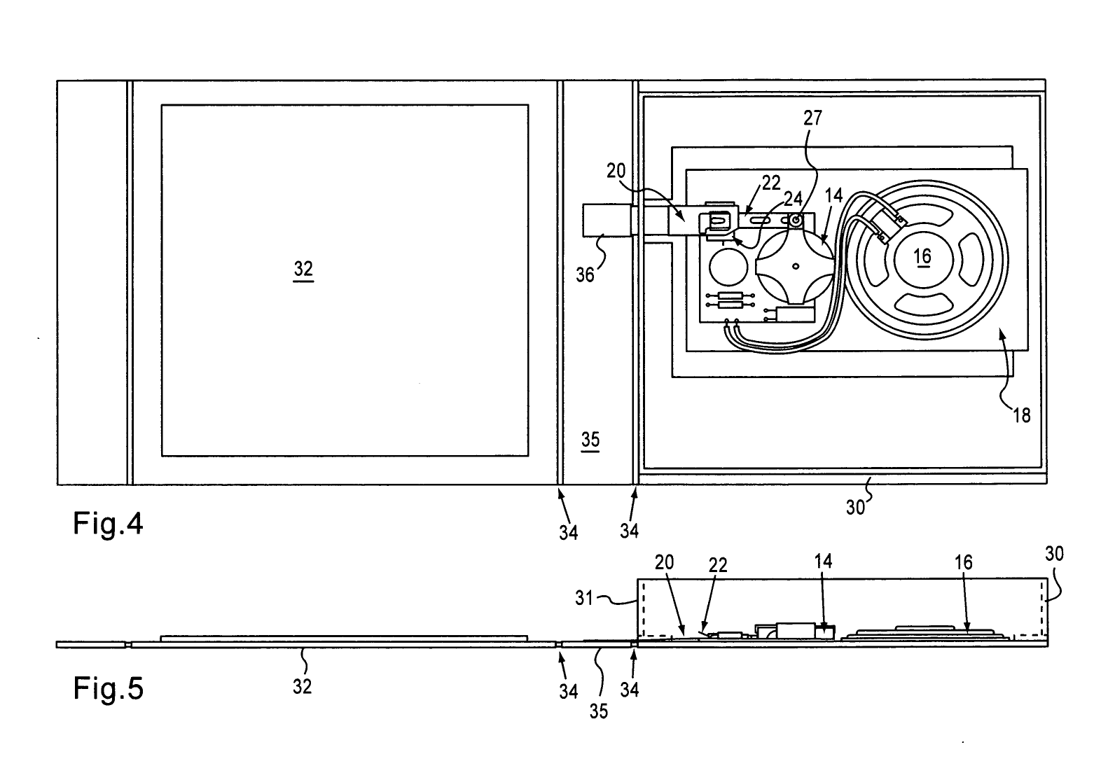

The preferred embodiment and best mode of the invention is shown in FIGS. 1 through 5. FIG. 1 shows a detailed plan view of the present invention showing the sound playback assembly 10, comprising circuit board 12, a battery 14 mounted on the circuit board 12, a speaker 16 electrically connected to the circuit board 12 by lead wires 17 and a switch assembly 20. The switch assembly 20 is constructed with a resilient spring biased electrically conductive first metal strip member 22 mounted to the circuit board 12, an electrically conductive second member 24 mounted to the circuit board 12 and an electrically insulated strip contact breaker 26. The playback assembly 10 and certain of the switch components are mounted to a platform or base member 18 having on its bottom surface a peel and stick backing mounting sheet 19 for easy attachment to a container or cover. Not shown is an additional amount of adhesive applied to the distal end of the sliding electrically insulating contact breaker 26 in sleeve 36 allowing attachment to segment 35 of the container cover 32.

The present invention is a novel combination of an electronic sound playback assembly 10 with a reciprocating switch assembly 20 mounted on a gift container 30. This switch assembly 20 is easily incorporated into existing or specially manufactured containers 30 and activated with the opening and closing of the cover 32 of the container 30. The container 30 can be of any size and dimension that can incorporate an electronic sound playback assembly which, when the container is opened, will play a high quality sound of music normally associated with sounds produced by an audio speaker. The cover 32 is mounted to container 30 and is hinged at 34 with a double hinge with the distance between the hinges forming a segment 35 which is substantially equal in width to the height of the container wall 31. It should be noted that the cover 32 may be provided with a single hinge when used with a larger container with the single hinge being formed at the top of the rear wall of the container 30. Alternatively, the cover may be able to be separately removed. The primary components of the switch assembly 20 include a biased resilient electrically conductive first member 22 which is held in place at on end on circuit board 12 by fastener 27 with the distal end 23 being bent upward, an electrically conductive second member 24, which is mounted beneath the biased electrically conductive first member 22 and is also mounted on circuit board 12 and a flexible electrically insulating strip contact breaker 26. Both electrically conductive first member and the electrically conductive second member 24 are mounted to the circuit board 12 and are electronically connected to circuit board 12. The resilient electrically conductive first member 22 is biased towards the second conductive member 24 such that it is in contact with the electrically conductive second member 24 when in its normal or resting position. The electrically insulating strip contact breaker 26 which is preferably constructed of an insulating plastic is positioned adjacent to the resilient electrically conductive first member 22 and may be reciprocated by movement of the cover 32 so that it is in a retracted position when the cover is opened thereby permitting the switch members 22, 24 to come into contact and complete an electrical circuit, or when in an extended position (cover is closed) is interposed between the switch members 22, 24 thereby disengaging the circuit. The strip shaped electrically insulating contact breaker 26 defines a cutout or an aperture 28 which is sized to accommodate the resilient electrically conductive first member 22 and allow the electrically insulated contact breaker 26 to move adjacent the resilient electrically conductive first member 22. The distal end of the electrically insulated contact breaker 26 is secured to the cover 32 of the container 30 in sleeve 36, allowing an exclusively reciprocating motion of the electrically insulated contact breaker 26 when the container cover 32 is opened or closed and prevents lateral movement of the electrically insulated contact breaker 26 relative to the longitudinal axis of the electrically conductive members 22, 24. Durability of the entire assembly is ensured thereby while ensuring cost effectiveness through ease of manufacturing.

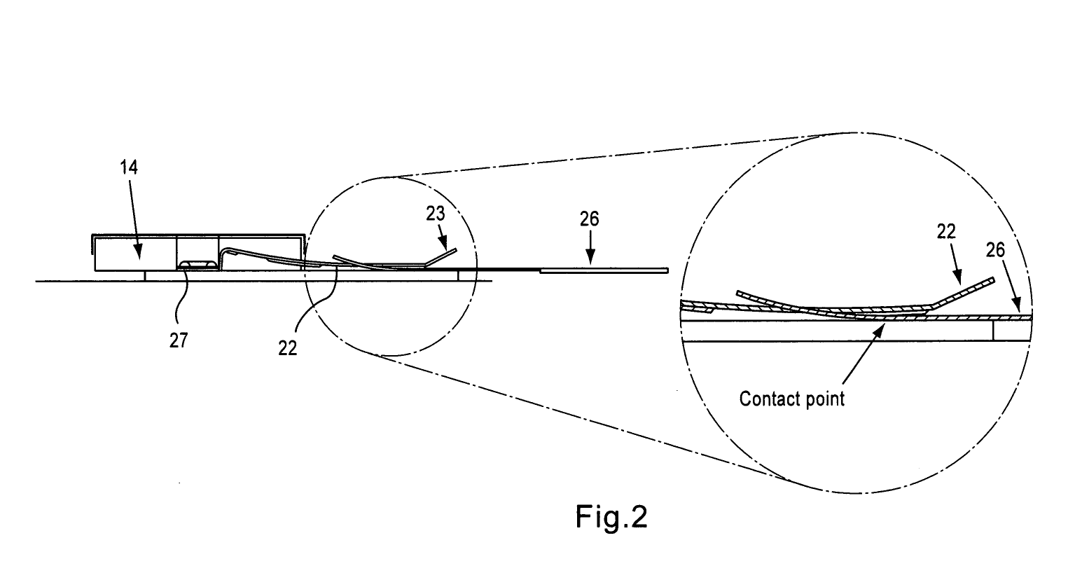

In a preferred embodiment, the electrically insulated contact breaker 26 defines an aperture 28 sized to allow insertion of the resilient electrically conductive first member 22. Referring to the elevation drawing in FIG. 1A, and FIGS. 2, 3, and 5, it is noted that mounting of the strip contact breaker 26 with the electrically conductive first member 22 is in a generally coplanar orientation although the distal end 23 of the resilient conductive first member 22 is inserted the aperture 28 of the electrically insulating strip contact breaker 26 and is angled upward away from the upper surface of the electrically insulating strip contact breaker 26.

While a preferred embodiment of this invention includes an aperture 28 in the electrically insulating strip contact breaker 26, it is understood that this invention may be practiced by the having the electrically insulating strip contact breaker 26 fixed adjacent to the resilient electrically conductive first member 22 in a manner that allows reciprocating movement and prevents lateral movement relative to the long axis of the electrically conductive members 22, 24. For example, this invention may also be successfully practiced using a generally “U” shaped cutout in lieu of the aperture 28 depicted in the drawings. Additional embodiments may include, but are not limited to a tube-like contact breaker essentially ensheathing the resilient electrically conductive first member 22.

In practice, the electronic sound playback assembly 10 and switch assembly 20 are mounted to the interior of the container 30 using the peel and stick mounting sheet 19 on the back of base member 18 and the distal end of the sliding electrically insulating strip contact breaker 26 is attached to the hinged segment 35 on the interior surface of the cover 32 so that opening and closing the container causes reciprocation of the electrically insulated strip contact breaker 26. Generally, opening the cover 32 on the container 30 will cause retraction of the electrically insulating strip contact breaker 26, thereby permitting the biased resilient electrically conductive first member 22 to bias against and contact the electrically conductive second member 24. An electrical circuit is completed and the electronic sound playback assembly 10 is then activated, playing a designated song or message. Closing the cover 32 on the container causes the strip contact breaker 26 to slide into a position interposed between the resilient electrically conductive first member 22 and the electrically conductive second member 24, thereby breaking or opening the circuit and stopping sound playback.

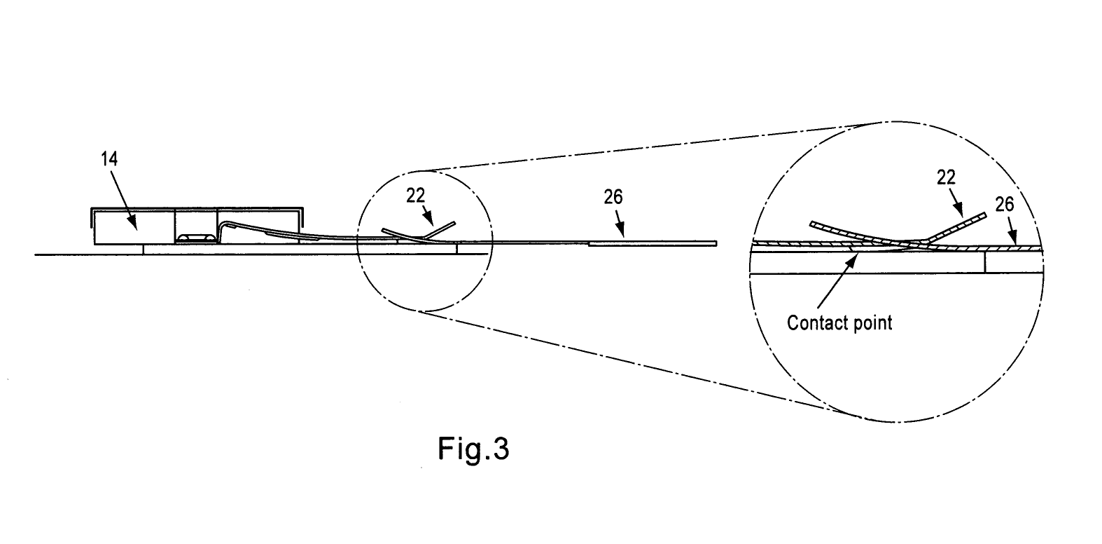

Thus, the attachment of the strip contact breaker 26 to the interior of the cover 32 causes the assembly to be activated when the container 30 is opened by lifting cover 32 and stops playback when the cover 32 is closed on the container 30. Opening and closing the cover 32 of the container 30 will reliably cause reciprocating movement in the electrically insulating strip contact breaker 26, as may be envisioned in the FIGS. 2 and 3 of the drawings. Appropriate placement and sizing of the aperture 28 ensures that sound playback will be activated upon opening the container, or alternatively, that closing the container will cause activation of the sound playback assembly. Additionally, a possibly less aesthetically pleasing but equally viable alternative is to mount the distal end of the electrically insulating strip contact breaker 26 to the exterior surface of the cover.

An important feature of the electrically insulating contact breaker is that it should be constructed from a material that is sufficiently flexible to conform to the dimensions of the container as necessary, but must also be sufficiently rigid to transmit the motion of the container cover to the switch elements.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A novelty sound generating container comprising:
a container, a cover moveably mounted to said container operable between closed and open positions;
an electrically operated sound generating assembly mounted to said container, said sound generating assembly comprising a sound generator circuit board, a battery electrically connected to said sound generator circuit board and a speaker electrically connected to said circuit board;
a switch means mounted to said container, said switch means comprising a resilient electrically conductive first member attached to said container and electrically connected to sound generating assembly, biased towards and engaging an electrically conductive second member attached to said container and electrically connected to said sound generating assembly; and,
a flexible electrically insulating element attached to said cover and positioned adjacent to said resilient electrically conductive first member, wherein said flexible electrically insulating element is reciprocatingly moveable in concert with the operation of said cover to activate or deactivate a circuit in said sound generator circuit board.

2. A novelty sound generating container as claimed in claim 1, wherein:
said resilient electrically conductive first member is in electrical communication with said electrically conductive second member.

3. A novelty sound generating container as claimed in claim 2, wherein said flexible electrically insulating element is reciprocatingly moveable to a first position interposed between said resilient electrically conductive first member and said electrically conductive second member wherein said resilient electrically conductive first member is prevented from contacting said electrically conductive second member.

4. A novelty sound generating container as claimed in claim 3, wherein said flexible electrically insulating element is reciprocatingly moveable to a second, retracted position wherein said resilient electrically conductive first member is in electrical communication with said electrically conductive second member.

5. A novelty sound generating container as claimed in claim 4, wherein said resilient electrically conductive first member in electrical communication with said electrically conductive second member completes an electrical circuit thereby activating said electrically operated sound generating assembly.

6. A novelty sound generating container as claimed in claim 1, wherein said flexible electrically insulating element is strip shaped and defines an aperture which receives a portion of said resilient electrically conductive first member.

7. A novelty sound generating container as claimed in claim 1, wherein said cover is mounted to said container by at least one hinge means.

8. A novelty sound generating container as claimed in claim 7, wherein said hinge means is a double hinge.

9. A novelty sound generating container comprising:
a container, a cover mounted to said container by hinge means operable between closed and open positions;
an electrically operated sound generating assembly mounted to said container, said sound generating assembly comprising a sound generator circuit board, a battery electrically connected to said sound generator circuit board and a speaker electrically connected to said sound generator circuit board;
a switch means mounted to said container, said switch means comprising a resilient electrically conductive first member mounted to said circuit board and electrically connected to sound generating assembly, said electrically conductive first member being biased towards and engaging an electrically conductive second member electrically connected to said sound generating assembly; a flexible reciprocally moveable electrically insulating member mounted to said cover and positioned adjacent to said resilient electrically conductive first member, wherein said flexible electrically insulating member is moveable in concert with the opening and closing of said cover to open or close said switch means.

10. A novelty sound generating container as claimed in claim 9, wherein said cover is mounted to said container by at least one hinge.

11. A novelty sound generating container as claimed in claim 9, wherein said hinge means is a double hinge.

12. A novelty sound generating container as claimed in claim 11, wherein said hinge means has space between each hinge which is substantially equal to the height of said container.

13. A novelty sound generating container as claimed in claim 9, wherein said flexible reciprocally moveable electrically insulating member defines an aperture therein which receives an end of resilient electrically conductive first member.

14. A novelty sound generating container as claimed in claim 13, wherein said end of said resilient electrically conductive first member is bent upward from said reciprocally moveable electrically insulating member.

15. A novelty sound generating container as claimed in claim 9, wherein said resilient electrically insulating member is constructed of plastic.

16. A novelty sound generating container as claimed in claim 9, wherein said sound generating assembly and said switch means is mounted on a base member.

17. A novelty sound generating container as claimed in claim 16, wherein said base member has an adhesive bottom surface.

18. A novelty sound generating container comprising:
a container with side walls and a closed bottom, a cover mounted to said container by hinge means operable between closed and open positions;
a base platform mounted to said container, an electrically operated sound generating assembly mounted to said base platform, said sound generating assembly comprising a sound generator circuit board, a batter electrically connected to said sound generator circuit board and a speaker electrically connected to said circuit board;
a switch means mounted to said container, said switch means comprising a resilient electrically conductive first member mounted to and electrically connected to sound generating assembly, said electrically conductive first member being biased towards and engaging an electrically conductive second member mounted to and electrically connected to said sound generating assembly; and,
a flexible electrically insulating element secured to said cover and mounted over to said resilient electrically conductive first member, wherein said flexible electrically insulating element is reciprocatingly moveable in concert with the operation of said cover, said flexible reciprocally moveable electrically insulating member defining an aperture therein which receives at least a portion electrically conductive first member in response to the opening and closing of said cover of resilient electrically conductive first member.

19. A novelty sound generating container as claimed in claim 18, wherein said hinge means is a double hinge with a space between substantially equal to the height of a rear wall of said container.

20. A novelty sound generating container as claimed in claim 17, wherein said base platform has an adhesive bottom surface
